(19) United States
(12) Patent Application Publication
(10) Pub. No.: US 2011/0233120 A1
(43) Pub. Date: Sep. 29, 2011

(54) FOOD SCRAP STRAINER

(76) Inventor: Calvin N. Ihler, Woodinville, WA (US)

(21) Appl. No.: 12/732,598

(22) Filed: Mar. 26, 2010

(51) Int. Cl. B01D 29/56; B01D 35/02; B23P 11/00

(52) U.S. Cl. 210/153; 210/335; 210/339; 210/232; 29/428; 29/426.2

(57) ABSTRACT

A food scrap strainer includes a housing, a first straining basket disposed within a lower portion of the housing, and a second straining basket disposed within the housing above the first straining basket. The housing includes a first retaining portion and a second retaining portion. The first basket includes a first flange and the second basket includes a second flange having an outer diameter smaller than an inner diameter of the first retaining portion and larger than an inner diameter of the second retaining portion. In an example embodiment, a sink bowl is attached to the housing, and a lip is attached to an upper portion of the sink bowl. A plurality of threaded extensions project downwardly from a lower side of the lip.

### FIELD OF THE INVENTION

This invention relates generally to straining devices and, more specifically, to food scrap straining devices and methods.

### BACKGROUND OF THE INVENTION

Garbage disposals are typically used to assist in the disposal of food waste scraps in high volume food service dishwashing environments. Increasingly, garbage disposals are being viewed as problematic, however, because the food waste enters municipal water treatment systems and can cause environmental difficulties. Additionally, garbage disposals have significant power requirements and a need for relatively constant water flow when in use. Garbage disposals also can become jammed by foreign objects such as silverware, resulting in a slow down of the dishwashing process. They are also expensive to purchase, repair, and maintain. Additionally, existing food scrap straining devices are generally awkward to use and clean, require powered pumps, and/or require the dishwashing process to stop during cleaning

### SUMMARY OF THE INVENTION

The present invention comprises a system for straining food scraps that includes a housing, a first straining basket disposed within an upper portion of the housing, and a second straining basket disposed within the housing below the first straining basket.

In accordance with some examples of the invention, the housing includes an upper retaining portion and a lower retaining portion, the first basket includes a first flange, and the second basket includes a second flange having an outer diameter smaller than an inner diameter of the upper retaining portion but larger than an inner diameter of the lower retaining portion.

In accordance with other examples of the invention, the housing includes an upper flange.

In accordance with still further examples of the invention, a sink bowl is attached to the housing.

In accordance with yet other examples of the invention, a lip is attached to an upper portion of the sink bowl and a plurality of threaded extensions project downwardly from a lower side of the lip.

In accordance with still another example of the invention, the strainer further includes a plurality of retaining tabs and the housing includes a plurality of retaining slots located on the exterior portion of the housing, each retaining slot structured to receive a lower portion of one of the retaining tabs.

In accordance with still further examples of the invention, a method of installing a food scrap strainer includes the steps of attaching a housing to a prewashing structure, inserting a lower straining basket having a lower basket flange into the housing past a first retaining structure until the lower basket flange rests on a second retaining structure, and inserting an upper straining basket having an upper basket flange into the housing such that the upper basket flange rests on the first retaining structure.

In accordance with yet another example of the invention, the method includes the step of removing a garbage disposal from the pre-washing structure before the step of attaching the housing.

In accordance with further examples of the invention, the method includes the step of removing a sink bowl from the prewashing structure before the step of attaching the housing and the step of attaching the housing includes attaching a sink bowl extending from the housing to the prewashing structure.

These and other examples of the invention will be described in further detail below.

### BRIEF DESCRIPTION OF THE DRAWINGS

Preferred and alternative embodiments of the present invention are described in detail below with reference to the following drawings:

FIG. 1 is a perspective view of a food scrap strainer in accordance with an example embodiment of the invention;

FIG. 2 is a bottom view of the upper basket and the lower basket of the strainer shown in FIG. 1;

FIG. 3 is a top view of the strainer shown in FIG. 1;

FIG. 4 is a cross-sectional side view of the strainer shown in FIG. 1;

FIG. 5 is a diagram showing a partial cross-sectional side view of an example installation of the strainer shown in FIG. 1;

FIG. 6 is a bottom view of the support leg shown in FIG. 5;

FIG. 7 is a cross-sectional side view of an embodiment of the invention having a threaded internal coupling for connection of an outlet pipe;

FIG. 8 is a cross-sectional side view of an embodiment of the invention having a plurality of tab receivers located on the housing;

FIG. 9 shows additional detail for an angled tab described with respect to FIG. 8;

FIG. 10 is a bottom view of the food scrap strainer shown in FIG. 8;

FIG. 11 is a cross-sectional side view of an embodiment of the invention having an upper sink portion;

FIG. 12 shows additional detail for a beveled flange and a threaded stud shown in FIG. 11;

FIG. 13 is a top view of a cover plate shown in FIG. 11;

FIG. 14 is a bottom view of the food scrap strainer shown in FIG. 11;

FIG. 15 is a partially cut away perspective view showing a cut line on a sink before installation of a food scrap strainer such as the embodiment shown in FIG. 8;

FIG. 16 is partially cut away perspective view of a sink showing mounting holes to be used in installation of a food scrap strainer such as the embodiment shown in FIG. 11; and

FIG. 17 is a flowchart of a method of installing a food scrap strainer in accordance with an embodiment of the invention.

### DETAILED DESCRIPTION OF THE PREFERRED EMBODIMENT

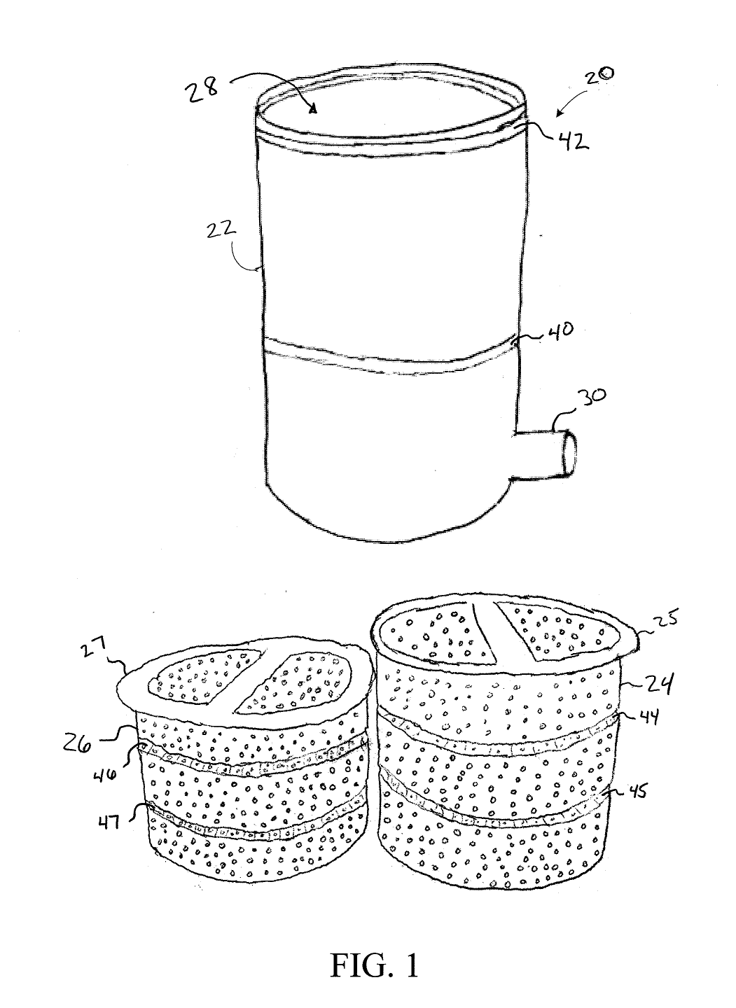

FIG. 1 is a perspective view of a food scrap strainer 20 in accordance with an example embodiment of the invention. The strainer 20 includes a housing 22, an upper basket 24, and a lower basket 26. The upper basket 24 and the lower basket 26 are formed of perforated stainless steel in a preferred embodiment, but may also be formed of other materials such as wire mesh, for example. The strainer 20 is shown with the upper basket 24 and the lower basket 26 removed from the housing 22. The housing 22 defines a circular opening 28 through which the lower basket 26 and the upper basket 24 are inserted. The upper basket 24 includes an upper basket flange 25 and the lower basket 26 includes a lower basket flange 27. The housing 22 also includes a drain pipe 30 at a lower end of the housing 22. Although the size of the strainer 20 may vary, the opening 28 is within a range of approximately seven to ten inches in diameter in the preferred embodiment of the invention and the depth of the housing 22 is approximately 15 inches in the preferred embodiment.

In the preferred embodiment, the housing 22, the upper basket 24, and the lower basket 26 are formed of kitchen grade stainless steel. However, other materials such as various types of polymeric materials may also be used. The housing 22 has a lower roll groove 40 that extends inwardly into the housing 22 interior such that the lower basket flange 27 rests on an interior portion of the roll groove 40 when the lower basket 26 is inserted into the housing 22. In similar fashion, the housing 22 has an upper roll groove 42 that also extends inwardly into the housing 22, but to a lesser degree than the lower roll groove 40 so that the lower basket flange 27 can pass through the inwardly extended portion of the roll groove 42 when inserted but the upper basket flange 25 will not pass by and rests on the inwardly extending portion of the upper roll groove 42. Although roll grooves are used in the preferred embodiment, other means of retaining the upper basket 24 and the lower basket 26 in place may also be used, such as by welding an upper and a lower retaining flange to the interior of the housing 22, for example. The upper basket 24 has an upper roll groove 44 and a lower roll groove 45 for additional structural support. In similar fashion, the lower basket 26 has an upper roll groove 46 and a lower roll groove 47. In other embodiments, one or more of the roll grooves on the upper basket 24 and/or the lower basket 26 may not be present.

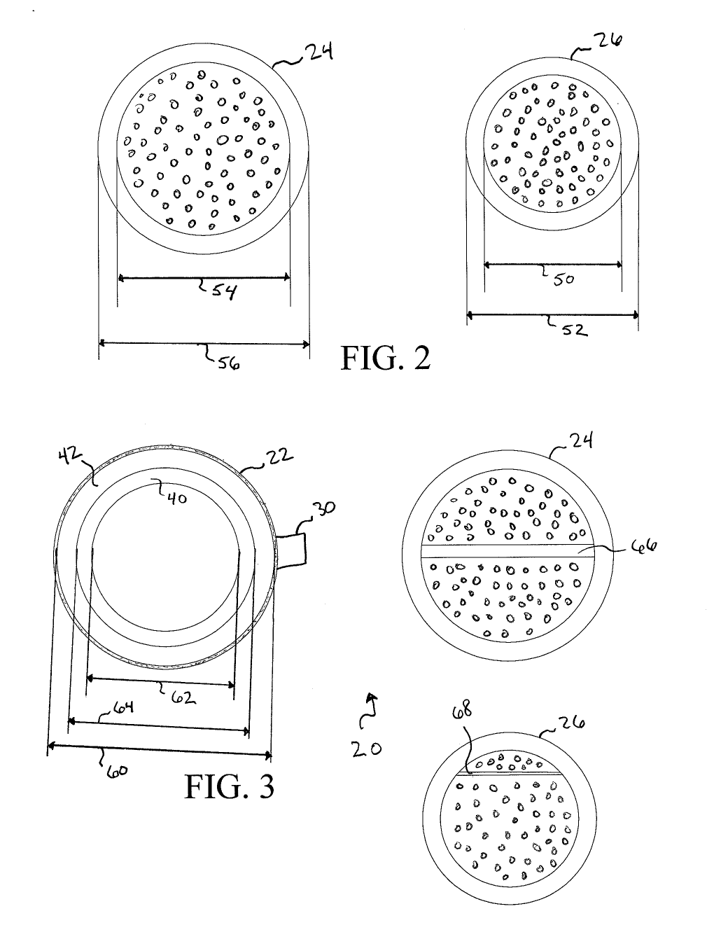

FIG. 2 is a bottom view of the upper basket 24 and the lower basket 26. The lower basket 26 has a lower basket diameter 50 and a lower basket flange diameter 52. The upper basket 24 has an upper basket diameter 54 and an upper basket flange diameter 56. FIG. 3 is a top view of the strainer 20 shown in FIG. 1 with the upper basket 24 and the lower basket 26 removed from the housing 22. The housing 22 has a top opening with diameter 60. The lower roll groove 40 has an inner diameter 62 and the upper roll groove has an inner diameter 64. The upper roll groove 42 is structured such that the inner diameter 64 is larger than the lower basket flange diameter 52 and the upper basket diameter 54 yet smaller than the upper basket flange diameter 56. The lower roll groove 40 is structured such that it is larger than the lower basket diameter 50 but smaller than the lower basket flange diameter 52. The upper basket has a handle 66 and the lower basket has a handle 68. Although the upper basket handle 66 and the lower basket handle 68 are shown in different forms in this figure, they may be similar to each other in other embodiments or may take a different form than those shown.

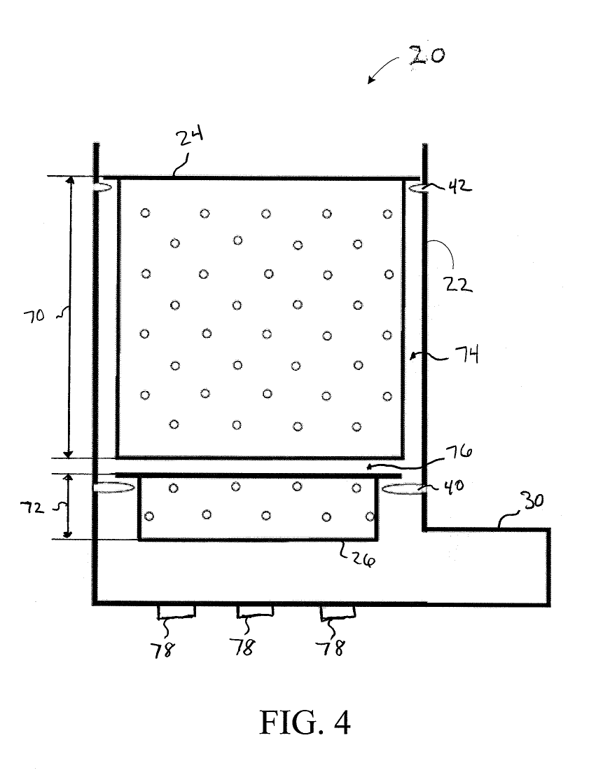

FIG. 4 is a cross-sectional side view of the strainer 20 shown in FIG. 1 showing the upper basket 24 and the lower basket 26 inserted into the housing 22. The various figures are not drawn to scale and the size relationships of one part to another may vary between figures. The upper basket 24 has an upper basket depth 70 and the lower basket has a lower basket depth 72. The position of the upper basket 24 defines a gap 74 between the outer wall of the upper basket 24 and the inner wall of the housing 22. The upper basket depth 70 in relation to the distance between the upper roll groove 42 and the lower roll groove 40 establishes the width of a gap 76 that is present between the bottom of the upper basket 24 and the flange 27 of the lower basket 26. In a preferred embodiment, the gap 74 and the gap 76 are each approximately one half inch wide. However, the gap widths may vary in other embodiments. The gaps 74 and 76 allow water to pass through the sides of the upper basket 24 and flow through the gaps 74 and 76 before entering the lower basket 26. This aids in the passage of water through the strainer 20 when the bottom of the upper strainer 24 becomes clogged with food scraps. The second basket depth 72 is preferably sized such that a gap of at least one quarter inch is present between the bottom of the lower basket 26 and the bottom of the housing 22. A plurality of nuts 78 are attached to the bottom of the housing 22 to allow attachment of a support stand.

Use of an upper basket and a lower basket allows the upper basket to be removed for emptying accumulated food scraps while leaving the lower basket in place to catch scraps as the pre-washing process continues while the upper basket is being emptied. Generally, the upper basket will be returned to its position in a relatively short time period so that the lower basket does not have a chance to accumulate food scraps and can be emptied infrequently. The lower basket also provides additional straining of some food particles that are not caught by the upper basket. Although the perforations of the upper and lower basket are the same size in the preferred embodiment, they may vary in other embodiments such as by using a lower basket with smaller perforations than the upper basket, for example.

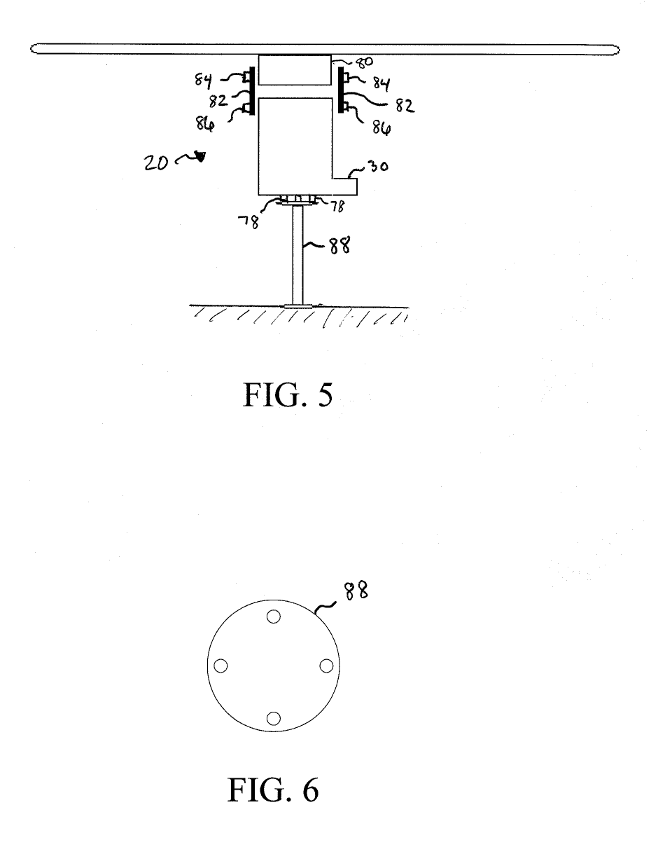

FIG. 5 is a cross-sectional side view showing an example installation of the strainer 20. Although spaces are shown between some of the parts for clarity, it should be understood that they would be in contact when installed. The strainer 20 is attached to a pipe 80 using a rubber coupling 82 that is clamped to the pipe 80 with a first band clamp 84 and to the housing 22 with a second band clamp 86. An adjustable leg 88 is positioned between the bottom of the housing 22 and a floor surface. FIG. 6 is a bottom view of the support leg 88 shown in FIG. 5. The support leg bottom defines four holes that can be used to bolt or otherwise affix the adjustable leg 88 to the floor for additional stability. In an example embodiment, a support leg top is structured in a similar manner such that the holes line up with the nuts 78 attached to the bottom of the housing 22 to allow the adjustable leg 88 to be easily bolted to the housing 22.

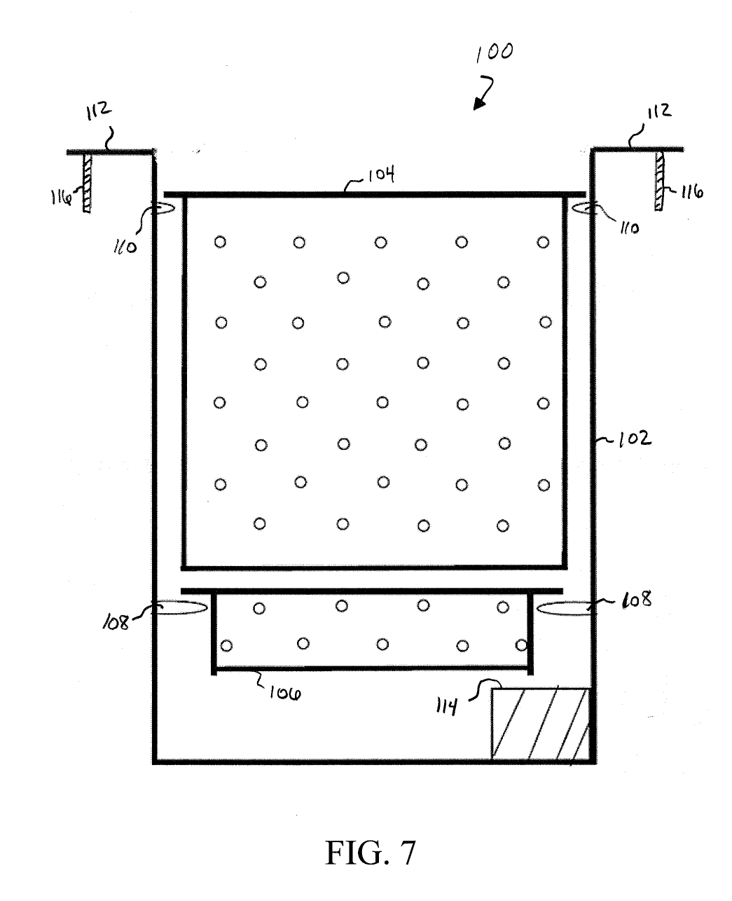

FIG. 7 is a cross-sectional side view of a food scrap strainer 100 according to an additional embodiment of the invention. The food scrap strainer 100 is similar to the food scrap strainer 20 in that the food scrap strainer 100 includes a housing 102, an upper basket 104, and a lower basket 106. The housing 100 includes a lower rolled portion 108 and an upper rolled portion 110 that are structured similarly to the roll grooves of the housing 22. The food scrap strainer 100 includes a flange 112 that extends from an upper rim of the housing 102. In an example embodiment, the flange 112 is welded to the housing 102. The food scrap strainer 100 also includes a pipe coupling 114 located at the bottom of the strainer 100 that provides recessed outlet threads so that a threaded outlet pipe can be attached to the strainer 100. In the embodiment shown, the lower basket 106 is not as deep as the lower basket 26 to allow space for the coupling 114. A plurality of threaded studs 116 extend downwardly from the flange 112.

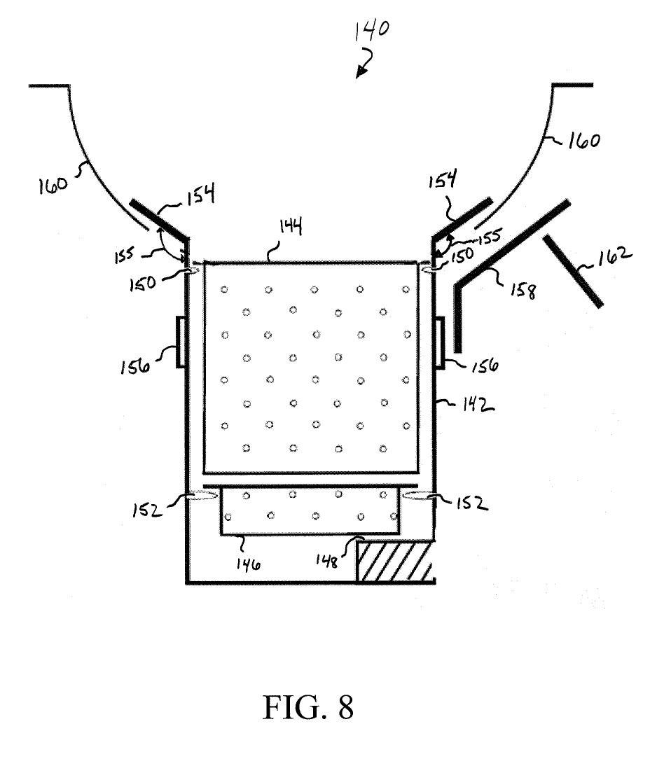

FIG. 8 is a cross-sectional side view of a food scrap strainer 140 according to an additional embodiment of the invention. The food scrap strainer 140 is similar to the food scrap strainer 100 shown in FIG. 7 in that the food scrap strainer 140 includes a housing 142, an upper basket 144, a lower basket 146, and a threaded coupling 148. The housing 142 also includes an upper rolled portion 150 and a lower rolled portion 152 that are structured in a similar way as those described with respect to the housing 22 in FIG. 1. The food scrap strainer 140 includes an upper flange 154 that extends from the housing 142 at an angle 155 so that the upper flange 154 will maintain a substantially flush contact with an upper surface of the sink bowl 160 when the strainer 140 is secured in place. A plurality of tab receivers 156 are located about the outside perimeter of the housing 142.

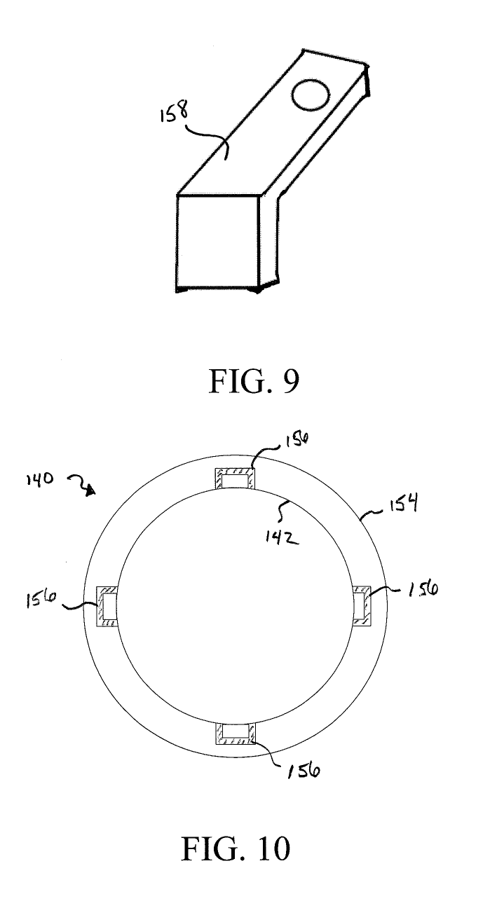

In this embodiment, the tab receivers 156 are structured such that they enclose a rectangular hole that extends longitudinally along the housing 142 between the housing 142 and the tab receivers 156. The food scrap strainer 140 also includes a plurality of angled tabs 158 each having a first end structured to fit through one of the tab receivers 156 and a second end that defines a threaded hole. During installation, the housing 142 is inserted through a hole in a sink bowl 160 until a lower side of the upper flange 154 contacts the sink 160. The angled tabs 158 are placed within the tab receivers 156 and a threaded stud 162 is screwed through the hole of each angled tab 158 to pull the flange 154 securely against the sink 160. A silicone based sealant or a product commonly known as plumber's putty may be applied between the flange 154 and the sink 160 before resting the flange 154 against the sink. FIG. 9 shows additional detail for one of the angled tabs 158. FIG. 10 is a bottom view of the food scrap strainer 140 showing that there are four tab receivers 156 in this embodiment.

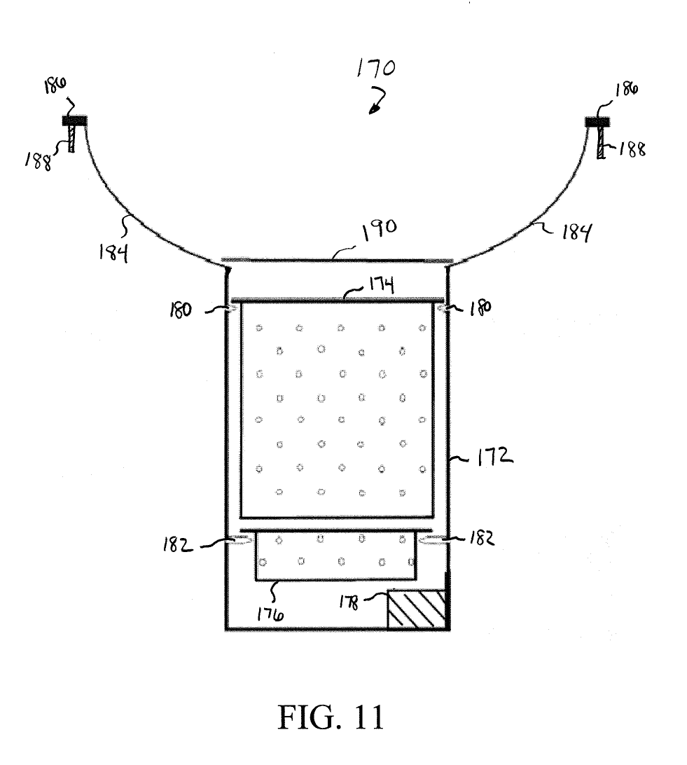

FIG. 11 is a cross-sectional side view of a food scrap strainer 170 in accordance with an additional embodiment of the invention. The food scrap strainer 170 is similar to the food scrap strainer 100 shown in FIG. 7 in that the strainer 170 includes a housing 172, an upper basket 174, a lower basket 176, and a threaded coupling 178. Although the threaded coupling 178 is shown, a drain pipe similar to the drain pipe 30 shown in FIG. 1 is used instead in other embodiments. The housing 172 also includes an upper rolled portion 180 and a lower rolled portion 182 that are structured in a similar way as those described with respect to the housing 22 in FIG. 1. The strainer 170 also includes an upper sink bowl 184 attached to the housing 172.

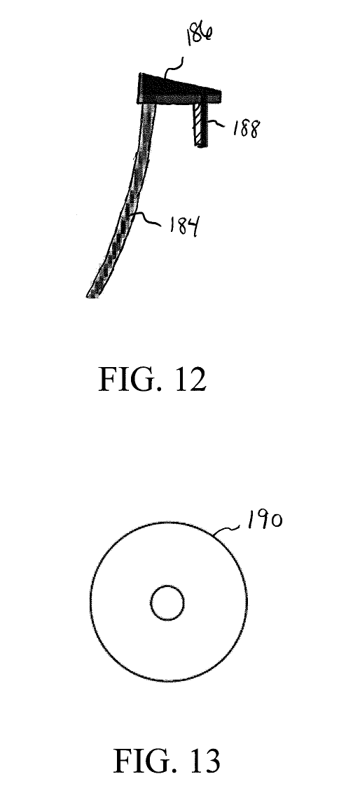

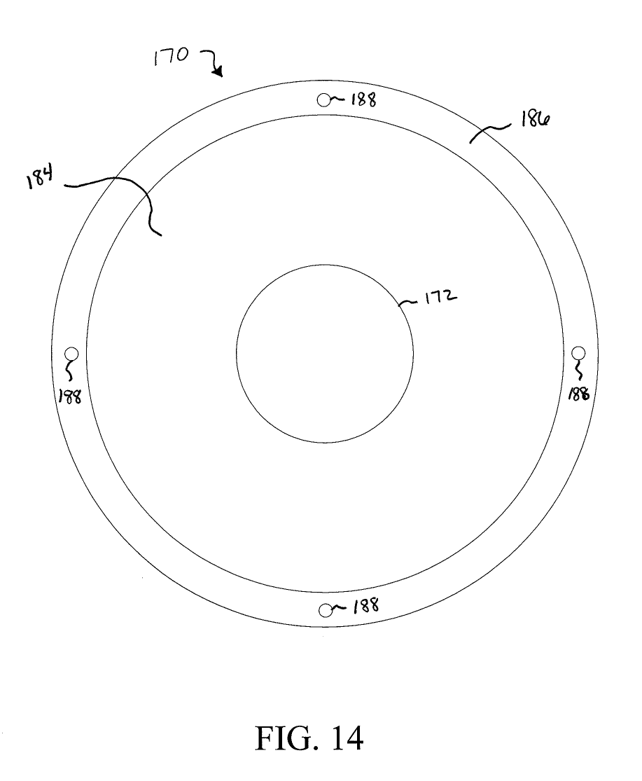

In this embodiment, a beveled flange 186 extends from a top rim of the upper sink bowl 184. A plurality of threaded studs 188 extend from an underside of the flange 186. Additional detail for the beveled flange 186 and one of the studs 188 is shown in FIG. 12. An optional cover plate 190 can be placed in a lower portion of the sink bowl 160 over the upper opening of the housing 172. A top view of the cover plate 190 is shown in FIG. 13. In an example embodiment, the cover plate 190 defines a central hole approximately three inches in diameter. FIG. 14 is a bottom view of the food scrap straining device shown in FIG. 11.

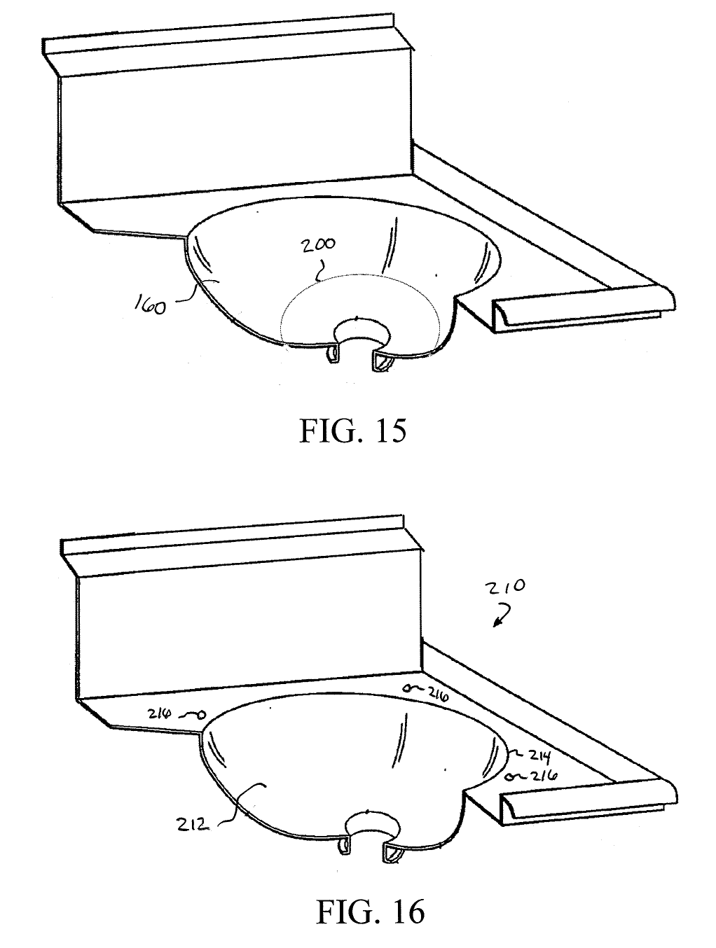

FIG. 15 is a partially cut away perspective view of a sink structure showing the sink bowl 160 described with respect to FIG. 8. The sink bowl 160 is cut at a cut line 200 before installation of a food scrap strainer such as the food scrap strainer 140 shown in FIG. 8.

FIG. 16 is a partially cut away perspective view of a sink structure 210. The sink structure 210 includes a sink bowl 212 that is removed by cutting along an upper edge 214 before a food scrap strainer such as the strainer 170 shown in FIG. 11 is installed. In addition to replacing a garbage disposal, the strainer 170 can be used to replace a cracked sink bowl in this manner so that the entire sink structure 210 need not be replaced. A plurality of mounting holes 216 are drilled into the sink structure 210 to match the pattern of the threaded studs 188 as shown in FIG. 14. This may be performed using a template (not shown) having holes in the same pattern as the threaded studs 188, for example.

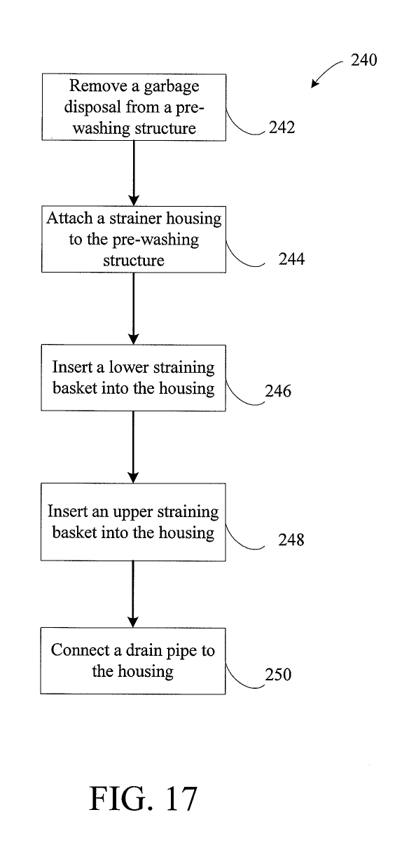

FIG. 17 is a flowchart of a method 240 of installing a food scrap strainer in accordance with an embodiment of the invention. First, at a block 242, a garbage disposal is removed from a pre-washing structure such as the structure 210 shown in FIG. 16, for example. Next, at a block 244, a strainer housing such as the housing 22 shown in FIG. 1 is attached to the pre-washing structure. In the case of the housing 22, the rubber coupling 82 is attached to the pre-washing structure and the housing 22 as shown in FIG. 5. Alternatively, a housing such as the housing 102 shown in FIG. 7 may be attached by first drilling holes in the pre-washing structure in a pattern that matches the placement of the threaded studs 116 followed by inserting the housing 102 through the pre-washing structure and securing the housing 102 in place by using nuts on the threaded studs 116. For a housing of a type such as the housing 142 shown in FIG. 8, a hole is cut in the pre-washing structure after removing the garbage disposal as described with respect to the cut line 200 shown in FIG. 15. The housing 142 is then attached as described with respect to FIG. 8. For a housing of a type such as the housing 172 shown in FIG. 11, an entire sink bowl is removed from the prewashing structure before attaching the housing 172.

Next, at a block 246, a lower straining basket such as the lower basket 26 with flange 27 shown in FIG. 1 is inserted into the housing past an upper retaining structure such as the inwardly extending portion of the upper roll groove 42 until the lower basket flange rests on a lower retaining structure such as the inwardly extending portion of the lower roll groove 40. Next, at a block 248, an upper straining basket such as the upper basket 24 with flange 25 is inserted into the housing such that the upper basket flange rests on the upper retaining structure. Then, at a block 250, a drain pipe is connected to the housing. In the case of a housing having a drain pipe such as the drain pipe 30 shown in FIG. 1, a rubber connector may be used along with band clamps to secure the drain pipe to additional plumbing. In the case of a housing having a threaded coupling such as the coupling 114 shown in FIG. 7, a threaded drain pipe is attached to the threaded coupling.

While the preferred embodiment of the invention has been illustrated and described, as noted above, many changes can be made without departing from the spirit and scope of the invention. For example, the strainer housing may be shaped in the form of an oval cylinder rather than a circular cylinder to suit installation in some types of sink bowls. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A food scrap strainer comprising:
a housing;
a first straining basket disposed within an upper portion of the housing; and
a second straining basket disposed within the housing below the first straining basket.

2. The food scrap strainer of claim 1, wherein the housing has an inner housing diameter and includes an upper retaining portion and a lower retaining portion, wherein the first basket includes a first flange, and wherein the second basket includes a second flange having an outer diameter smaller than an inner diameter of the upper retaining portion and larger than an inner diameter of the lower retaining portion.

3. The food scrap strainer of claim 2, wherein the housing includes an upper flange.

4. The food scrap strainer of claim 2, wherein the first basket includes an outer wall, the housing includes an inner wall, and the outer wall of the first basket is located at least one half inch from the inner wall of the housing when the first flange rests on the upper retaining portion.

5. The food scrap strainer of claim 4, wherein the first basket includes a bottom surface, the second basket includes an upper flange surface, and the bottom surface of the first basket is located at least one half inch from the upper flange surface of the second basket when the first flange rests on the upper retaining portion and the second flange rests on the lower retaining portion.

6. The food scrap strainer of claim 1, further comprising a sink bowl attached to the housing.

7. The food scrap strainer of claim 5, further comprising a lip attached to an upper portion of the sink bowl.

8. The food scrap strainer of claim 7, further comprising a plurality of threaded extensions projecting downwardly from a lower side of the lip.

9. The food scrap strainer of claim 1, wherein the housing includes an upper flange, the upper flange attached to the housing such that an angle of at least 100 degrees is present between a lower side of the flange and an exterior portion of the housing.

10. The food scrap strainer of claim 9, further comprising a plurality of retaining tabs, wherein the housing includes a plurality of retaining slots located on the exterior portion of the housing, each retaining slot structured to receive a lower portion of one of the retaining tabs.

11. The food scrap strainer of claim 10, wherein each retaining tab includes an upper portion structured to define a threaded hole.

12. The food scrap strainer of claim 1, further comprising an outlet pipe extending from the housing.

13. The food scrap strainer of claim 1, further comprising a threaded coupling within the housing.

14. A method of installing a food scrap strainer comprising the steps of:
attaching a housing to a prewashing structure;
inserting a lower straining basket having a lower basket flange into the housing past a first retaining structure until the lower basket flange rests on a second retaining structure; and
inserting an upper straining basket having an upper basket flange into the housing such that the upper basket flange rests on the first retaining structure.

15. The method of claim 14, wherein the method further comprises the step of removing a garbage disposal from the prewashing structure before attaching the housing.
